(19) United States
(12) Patent Application Publication
(10) Pub. No.: US 2008/0125616 A1
(43) Pub. Date: May 29, 2008

(54) Method for stabilization of Pb and Cd from incinerator ash

(76) Inventor: Keith Edward Forrester, Meredith, NH (US)

Correspondence Address: Keith E. Forrester, 78 Tracy Way, Meredith, NH, 03253, US

(21) Appl. No.: 11/978,354

(22) Filed: Oct. 29, 2007

Related U.S. Application Data
(60) Provisional application No. 60/861,396, filed on Nov. 27, 2006.

(51) Int. Cl. A62D 3/36

(52) U.S. Cl. 588/318

(57) ABSTRACT

This invention provides a method for stabilization of incinerator ash subject to acid and water leaching tests or leach conditions by adjustment of the facility acid gas scrubber excess lime and optional addition of stabilization agents, such that leaching of lead and cadmium are inhibited to desired levels. The resultant ash after stabilization is suitable for disposal as RCRA non-hazardous waste.

### BACKGROUND OF THE INVENTION

Heavy metal bearing air pollution unit collected flyash, air pollution control unit generated scrubber residue and bottom ash combinations from mass burn refuse incinerators and refuse derived fuel incinerators may be deemed “Hazardous Waste” by the United States Environmental Protection Agency (USEPA) pursuant to 40 C.F.R. Part 261 and also deemed hazardous under similar regulations in other countries such as Japan, Switzerland, Germany, United Kingdom, Mexico, Australia, Canada, Taiwan, European Countries, India, and China, and deemed special waste within specific regions or states within those countries, if containing designated leachate solution-soluble and/or sub-micron filter-passing particle sized lead (Pb) and Cadmium (Cd) above levels deemed hazardous by those country, regional or state regulators. Scrubber residue is most commonly a lime-based solid product produced from the interaction between either dry or slurry lime as CaOH or CaOH(x) and acid gas components derived from the combustion of refuse which generate gases as sulfur dioxides and hydrogen chlorides regulated under the Clean Air Act and Amendments thereto. Some scrubbers referred to as dry lime scrubbers operate by injecting a fine-powder dry lime prior to a baghouse collection unit, which produces a high level of pH and excess lime in the scrubber residue due to incomplete lime consumption by acid gas. Most scrubbers use a wet slurry lime, hydrated on-site in mixing units and injected into a spray tower which provides for a very efficient lime consumption and low lime excess remaining in the scrubber residue stream. Both scrubber methods produce some degree of excess lime and most scrubbers are operated at a lime feed rate that meets the acid gas scrubbing requirement with little excess lime usage, hence lowest lime cost state.

In the United States, any industrial solid waste such as collected flyash and scrubber residue can be defined as Hazardous Waste either because it is “listed” in 40 C.F.R., Part 261 Subpart D, federal regulations adopted pursuant to the Resource Conservation and Recovery Act (RCRA), or because it exhibits one or more of the characteristics of a Hazardous Waste as defined in 40 C.F.R. Part 261, Subpart C. The hazard characteristics defined under 40 CFR Part 261 are: (1) ignitability, (2) corrosivity, (3) reactivity, and (4) toxicity as tested under the Toxicity Characteristic Leaching Procedure (TCLP). 40 C.F.R., Part 261.24(a), contains a list of heavy metals and their associated maximum allowable concentrations. If a heavy metal, such as lead or cadmium, exceeds its maximum allowable concentration from a solid waste, when tested using the TCLP analysis as specified at 40 C.F.R. Part 261 Appendix 2, then the solid waste is classified as RCRA Hazardous Waste. The USEPA TCLP test uses a dilute acetic acid either in de-ionized water (TCLP fluid 2) or in de-ionized water with a sodium hydroxide buffer (TCLP fluid 1). Both extract methods attempt to simulate the leachate character from a decomposing trash landfill in which the solid waste being tested for is assumed to be disposed in and thus subject to rainwater and decomposing organic matter leachate combination . . . or an acetic acid leaching condition. Waste containing leachable heavy metals is currently classified as hazardous waste due to the toxicity characteristic, if the level of TCLP analysis is above 0.2 to 100 milligrams per liter (mg/L) or parts per millions (ppm) for specific heavy metals. The TCLP test is designed to simulate a worst-case leaching situation . . . that is a leaching environment typically found in the interior of an actively degrading municipal landfill. Such landfills normally are slightly acidic with a pH of approximately 5±0.5. Countries outside of the US also use the TCLP test as a measure of leaching such as Thailand, Taiwan, and Canada. Thailand also limits solubility of Cu and Zn, as these are metals of concern to Thailand groundwater. Switzerland, Mexico, Europe and Japan regulate management of solid wastes by measuring heavy metals and salts as tested by a sequential leaching method using carbonated water simulating rainwater, synthetic rainwater and de-ionized water sequential testing. Additionally, U.S. EPA land disposal restrictions prohibit the land disposal of solid waste leaching in excess of maximum allowable concentrations upon performance of the TCLP analysis. The land disposal regulations require that hazardous wastes are treated until the heavy metals do not leach at levels from the solid waste at levels above the maximum allowable concentrations prior to placement in a surface impoundment, waste pile, landfill or other land disposal unit as defined in 40 C.F.R. 260.10.

Suitable acetic acid leach tests include the USEPA SW-846 Manual described Toxicity Characteristic Leaching Procedure (TCLP) and Extraction Procedure Toxicity Test (EP Tox) now used in Canada. Briefly, in a TCLP test, 100 grams of waste are tumbled with 2000 ml of dilute and buffered or non-buffered acetic acid for 18 hours and then filtered through a 0.75 micron filter prior to nitric acid digestion and final ICP analyses for total “soluble” metals. The extract solution is made up from 5.7 ml of glacial acetic acid and 64.3 ml of 1.0 normal sodium hydroxide up to 1000 ml dilution with reagent water.

Suitable water leach tests include the Japanese leach test which tumbles 50 grams of composited waste sample in 500 ml of water for 6 hours held at pH 5.8 to 6.3, followed by centrifuge and 0.45 micron filtration prior to analyses. Another suitable distilled water CO₂ saturated method is the Swiss protocol using 100 grams of cemented waste at 1 cm³ in two (2) sequential water baths of 2000 ml. The concentration of lead and salts are measured for each bath and averaged together before comparison to the Swiss criteria.

Suitable citric acid leach tests include the California Waste Extraction Test (WET), which is described in Title 22, Section 66700, “Environmental Health” of the California Health & Safety Code. Briefly, in a WET test, 50 grams of waste are tumbled in a 1000 ml tumbler with 500 grams of sodium citrate solution for a period of 48 hours. The concentration of leached lead is then analyzed by Inductively-Coupled Plasma (ICP) after filtration of a 100 ml aliquot from the tumbler through a 45 micron glass bead filter.

The present invention provides a method of reducing the solubility of Pb and Cd bearing flyash, scrubber residue and bottom ash combinations produced from refuse incinerators which utilize acid gas scrubbing technology incorporating calcium oxide (CaO) in either hydrated or non-hydrated form. Pb and Cd are controlled by the invention under TCLP, SPLP, CALWET, MEP, rainwater and surface water leaching conditions as well as under regulatory water extraction test conditions as defined by waste control regulations in Thailand, Taiwan, Japan, Canada, UK, Mexico, Switzerland, Germany, Sweden, The Netherlands and under American Nuclear Standards for sequential leaching of wastes by de-ionized water. Unlike the present invention, prior art has focused on reducing solubility of Pb in ash residues by application of stabilizers such as cement, sulfides, silicates and water soluble phosphoric acid (Forrester U.S. Pat. No. 5,245,114) and use of a water insoluble and polymer coated phosphate sources (Forrester U.S. Pat. No. 5,860,908) without consideration of the final pH of the leachate test and the value of adjusting the matrix pH with the facility scrubber to a pH value for improved solubility control of Pb and Cd regardless of mineral type of either metal. These previous methods also fail to recognize the importance of providing for water soluble or water insoluble phosphate source for apatite mineral(s) formation or other stabilizing agents in combination with adjustment of the incinerator facility acid gas scrubber lime feed rate to generate a final extract fluid pH range which produces a low solubility range for all possible generated Pb and Cd minerals. The present method recognizes that Cd solubility will decrease with increased extract fluid pH levels at above 6.0 and that Pb solubility will also decrease above fluid pH levels above about 6.0 and below 11.0 units. The extract pH levels above 11.0 increase Pb solubility yet further decrease Cd solubility. Accordingly, an increase in scrubber lime dosage without attention to the extract final pH level can produce an overdose where lead solubility is too high thus causing amphoteric lead leach-out.

U.S. Pat. No. 5,202,033 describes an in-situ method for decreasing Pb TCLP leaching from solid waste using a combination of solid waste additives and additional pH controlling agents from the source of phosphate, carbonate, and sulfates.

U.S. Pat. No. 5,037,479 discloses a method for treating highly hazardous waste containing unacceptable levels of TCLP Pb such as lead by mixing the solid waste with a buffering agent selected from the group consisting of magnesium oxide, magnesium hydroxide, reactive calcium carbonates and reactive magnesium carbonates with an additional agent which is either an acid or salt containing an anion from the group consisting of Triple Superphosphate (TSP), ammonium phosphate, diammonium phosphate, phosphoric acid, boric acid and metallic iron.

U.S. Pat. No. 4,889,640 discloses a method and mixture from treating TCLP hazardous lead by mixing the solid waste with an agent selected from the group consisting of reactive calcium carbonate, reactive magnesium carbonate and reactive calcium magnesium carbonate.

U.S. Pat. No. 4,652,381 discloses a process for treating industrial wastewater contaminated with battery plant waste, such as sulfuric acid and heavy metals by treating the waste waster with calcium carbonate, calcium sulfate, calcium hydroxide to complete a separation of the heavy metals. However, this is not for use in a solid waste situation.

### SUMMARY OF THE INVENTION

The present invention discloses a Pb and Cd bearing flyash, scrubber residue and bottom ash combination stabilization method through contact of flyash, scrubber residue and bottom ash with optional stabilizing agents including sulfates, sulfides, carbonates, silicates, Portland cement, cement kiln dust, phosphates, and combinations thereof which are properly chosen to complement the lead and cadmium substitution into low solubility minerals, in combination with adjustment of the facility scrubber lime dosage to generate a leach test extract pH range where the solubility of lead and cadmium minerals within the flyash, scrubber residue and bottom ash, are at a low levels regardless of mineral form of such metals.

It is anticipated that the stabilizer and pH adjustment combination can be used for both reactive compliance and remedial actions as well as proactive leaching reduction means such that generated ash and residue does not exceed hazardous waste criteria. The preferred method of application of stabilizer agents and adjustment of facility scrubber lime feed rate would be in-line within the ash and residue collection units, and thus eliminating the need for expensive ash conditioning or mixing equipment and also allowed under USEPA regulations (RCRA) as totally enclosed, in-line exempt method of TCLP stabilization without the need for a RCRA Part B hazardous waste treatment and storage facility permit.

### DETAILED DESCRIPTION

Environmental regulations throughout the world such as those developed by the USEPA under RCRA and CERCLA require heavy metal bearing waste and material producers to manage such materials and wastes in a manner safe to the environment and protective of human health. In response to these regulations, environmental engineers and scientists have developed numerous means to control heavy metals, mostly through chemical applications which convert the solubility of the material and waste character to a less soluble form, thus passing leach tests and allowing the wastes to be either reused on-site or disposed at local landfills without further and more expensive control means such as hazardous waste disposal landfills or facilities designed to provide metals stabilization. The primary focus of scientists has been on reducing solubility of heavy metals such as lead, cadmium, chromium, arsenic and mercury, as these were and continue to be the most significant mass of metals contamination in our environment. Materials such as paints, cleanup site wastes such as battery acids, and industrial operations produced ash and scrubber wastes from fossil fuel combustors, smelters and incinerators are major lead sources.

Scrubber residue is most commonly a lime-based solid product produced from the interaction between either dry or slurry lime as CaOH or CaOH(x) and acid gas components derived from the combustion of refuse which generates gases as sulfur dioxides and hydrogen chlorides regulated under the Clean Air Act and Amendments thereto. Some scrubbers referred to as dry lime scrubbers operate by injecting a fine-powder dry lime prior to a baghouse collection unit, which produces a high level of pH and excess lime in the scrubber residue due to incomplete lime consumption by acid gas. Most scrubbers use a wet slurry lime, hydrated on-site in mixing units and injected into a spray tower which provides for a very efficient lime consumption and lower lime excess remaining in the scrubber residue stream.

There exists a demand for control of leaching of lead and cadmium from flyash, scrubber residues, and bottom ash combinations. The present invention discloses a Pb and Cd bearing flyash, scrubber residue and bottom ash combination ash method through optional contact with stabilizing agent including phosphates, cements, cement kiln dust, silicates, sulfides, sulfates, carbonates, and combinations thereof, and adjustment of the facility lime based acid gas scrubber to produce a leach test extract pH at a level of about between 6.0 and 11.0 units where lead and cadmium minerals within the ash matrix are at a low level of solubility.

It is anticipated that the stabilizers and pH adjustment can be used for RCRA compliance actions such that generated waste does not exceed appropriate TCLP hazardous waste criteria, and under TCLP or CERCLA (Superfund) response where stabilizers and acid agent are added to waste piles or storage vessels previously generated. The preferred method of application of stabilizers would be in-line within the ash and residue handling systems, and thus allowed under RCRA as a totally enclosed, in-line or exempt method of TCLP stabilization without the need for a RCRA Part B hazardous waste treatment and storage facility permit(s).

The scrubber lime dose adjustment and optional stabilizing agents including silicates, sulfates, sulfides, carbonates, cement, cement kiln dust, calcium phosphates, phosphates, and combinations thereof with the phosphate group including but not limited to wet process amber phosphoric acid, wet process green phosphoric acid, aluminum finishing Coproduct blends of phosphoric acid and sulfuric acid, technical grade phosphoric acid, monoammonia phosphate (MAP), diammonium phosphate (DAP), single superphosphate (SSP), triple superphosphate (TSP), hexametaphosphate (HMP), tetrapotassium polyphosphate, dicalcium phosphate, tricalcium phosphate, monocalcium phosphate, phosphate rock, pulverized forms of all above dry phosphates, and combinations thereof, would be selected through laboratory treatability and/or bench scale testing to provide sufficient control of metals solubility. In certain cases, such as with the use of amber and green phosphoric acid, phosphates may embody sulfuric acid, vanadium, iron, aluminum and other complexing agents which could also provide for a single-step formation of complexed heavy metal minerals. The stabilizer and scrubber adjustment, lime dose rate, contact duration, and application means would be engineered for each type of incinerator ash production facility.

Although the exact stabilization formation minerals are undetermined at this time, it is expected that when lead and cadmium come into contact with the excess scrubber lime and stabilizing agents and sufficient reaction time and energy, low extract fluid soluble minerals form such as a Pb substituted hydroxyapatite and Cd hydroxides through substitution or surface bonding, which are less soluble than the heavy metal element or molecule originally in the ash. The combination of low solubility range pH and stabilizer will provide a dual control method of lead and cadmium solubility control . . . which is important in applications where complete formation of low soluble lead and cadmium minerals are not achieved. Such incomplete lead and cadmium mineral formation environments could occur where phosphates are consumed by iron and calcium within the ash and residue, where available stabilizer levels are too low for complete stabilization, where stabilizer to lead and cadmium contact is incomplete such as with dry ash conditioning systems or where dry ash and residue agglomerating systems are selected such as with roll compaction briquette units which require low water content.

The optimum leaching test fluid pH for obtaining the lowest lead solubility will vary from ash and scrubber residue type and production, although anticipated to range from a final extract pH of 6.0 to 11.0 units. As leach tests used throughout the world also vary as to extractor size, sample size, tumbling method, extract fluid (i.e., water, acetic acid, citric acid, synthetic rainwater, carbonated water, distilled water), the optimum pH range will be obtained through varying degrees of pH adjustment via the facility scrubber dose as well as Pb and Cd stabilizer dose. One skilled in the art of laboratory treatability studies will be able to develop two-dimensional dose-response relationships for a specific ash and residue combination and specific leaching method, and thus determine the best cost means of stabilization and pH adjustment-by-scrubber combination.

Examples of suitable stabilizing agents include, but are not limited to sulfates, sulfides, silicates, cements, cement kiln dust, calcium phosphates, phosphate fertilizers, phosphate rock, pulverized phosphate rock, calcium orthophosphates, monocalcium phosphate, dicalcium phosphate, tricalcium phosphate, trisodium phosphates, natural phosphates, phosphoric acids, dry process technical grade phosphoric acid, wet process green phosphoric acid, wet process amber phosphoric acid, black phosphoric acid, merchant grade phosphoric acid, aluminum finishing phosphoric and sulfuric acid solution, hypophosphoric acid, metaphosphoric acid, hexametaphosphate, tertrapotassium polyphosphate, polyphosphates, trisodium phosphates, pyrophosphoric acid, fishbone phosphate, animal bone phosphate, herring meal, bone meal, phosphorites, and combinations thereof. Salts of phosphoric acid can be used and are preferably alkali metal salts such as, but not limited to, trisodium phosphate, dicalcium phosphate, disodium hydrogen phosphate, sodium dihydrogen phosphate, tripotassium phosphate, dipotassium hydrogen phosphate, potassium dihydrogen phosphate, trilithium phosphate, dilithium hydrogen phosphate, lithium dihydrogen phosphate or mixtures thereof. Examples of suitable pH fluid adjustment agents used for scrubbing acid gas include lime, hydrated lime, slurry lime, magnesium oxide, dolomitic lime, and bicarbonate. It is anticipated that slurried high calcium lime will be the least cost means of adjusting the ash and scrubber residue leach test pH to a level where lead and cadmium minerals are least soluble.

The amounts of stabilizing agent and scrubber pH adjustment agent used, according to the method of invention, depend on various factors including desired solubility reduction potential, leaching test method, desired mineral toxicity, and desired mineral formation relating to toxicological and site environmental control objectives. It has been found that addition of 0% to 6% triple super phosphate and 1% to 20% scrubber lime feed rate increase above dose required for acid gas control by weight of incinerator ash and scrubber residue was sufficient for TCLP Pb and Cd stabilization to less than RCRA 5.0 ppm and 1.0 ppm limit respectively. However, the foregoing is not intended to preclude yet higher or lower usage of stabilizing agent(s), scrubber dose adjustment, or combinations.

The examples below are merely illustrative of this invention and are not intended to limit it thereby in any way.

### EXAMPLE

Mass burn refuse incinerator combined ash (flyash, scrubber residue and bottom ash combination using a slurry lime acid gas scrubber), was combined with 0% and 1% Triple Superphosphate (TSP) wwb ash and the facility scrubber was adjusted to a higher dose rate of 5% above stoichiometric required for acid gas controls to produce a final TCLP fluid 2 extract fluid pH of 10.0 units. The mixed stabilized sample was not allowed to cure and was subjected to TCLP analyses Method 1311 and extract digestion by EPA method 200.7.

TABLE 1

| Addition | TCLP Pb/Cd (ppm) | Fluid pH (18 hr) |
|---|---|---|
| Baseline | 10.7/1.4 | 5.7 |
| 0% TSP + 5% scrubber | 1.4/0.12 | 10.0 |
| 1% TSP + 5% scrubber | 0.02/0.06 | 9.8 |

The foregoing results in Example 1 readily established the operability of the present process to stabilize lead and cadmium bearing ash thus reducing leachability to less than the regulatory limit. Given the effectiveness of the stabilizing agent and pH leach test endpoint in causing lead and cadmium to stabilize as presented in the Table 1, it is believed that an amount of the stabilization agent and pH adjustment equivalent to less than 1% by weight of ash and 5% scrubber dose increase should be effective.

While this invention has been particularly shown and described with reference to preferred embodiments thereof, it will be understood by those skilled in the art that various changes in form and details may be made therein without departing from the spirit and scope of the invention as defined by the appended claims.

I claim:

1. A method of reducing the solubility of lead and cadmium from refuse incinerator flyash, scrubber residue and bottom ash mixtures, comprising adjusting the facility acid gas scrubber to produce a final extract pH level in a range where the solubility of lead and cadmium from the ash mixture is at a level no more than non-hazardous levels as determined in an EPA TCLP test, performed on the stabilized material or waste, as set forth in the Federal Register, vol. 55, no. 126, pp. 26985-26998 (Jun. 29, 1990).

2. A method of reducing the solubility of lead and cadmium from refuse incinerator flyash, scrubber residue and bottom ash mixtures, comprising addition of at lease one heavy metal stabilizing agent in combination with adjusting the facility acid gas scrubber to produce a final extract pH level in a range where the solubility of lead and cadmium from the ash mixture is at a level no more than non-hazardous levels as determined in an EPA TCLP test, performed on the stabilized material or waste, as set forth in the Federal Register, vol. 55, no. 126, pp. 26985-26998 (Jun. 29, 1990).

3. The method of claim 2, wherein the stabilizing agent is selected from the group consisting of phosphates, sulfates, sulfides, Portland cement, silicates, cement kiln dust, ferric chloride and mineral complexing agent combinations, wet process amber phosphoric acid, wet process green phosphoric acid, coproduct phosphoric acid solution from aluminum polishing, technical grade phosphoric acid, hexametaphosphate, polyphosphate, calcium orthophosphate, superphosphate, triple superphosphate, phosphate fertilizers, phosphate rock, bone phosphate, fishbone phosphates, tetrapotassium polyphosphate, monocalcium phosphate, monoammonia phosphate, diammonium phosphate, dicalcium phosphate, tricalcium phosphate, trisodium phosphate, salts of phosphoric acid, and combinations thereof.

4. A method of claim 1 wherein reduction of solubility is to a level no more than non-hazardous levels as determined under leach tests other than USEPA Method 1311 TCLP including the California Wet Test, USEPA Method 1310 Synthetic Precipitant Leaching Procedure, USEPA Method 1312 Multiple Extraction Procedure, and by leach tests in countries other than the USA including but not limited to Switzerland, Mexico, Taiwan, Japan, China, Canada, Germany, and Europe.

5. A method of claim 2 wherein reduction of solubility is to a level no more than non-hazardous levels as determined under leach tests other than USEPA Method 1311 TCLP including the California Wet Test, USEPA Method 1310 Synthetic Precipitant Leaching Procedure, USEPA Method 1312 Multiple Extraction Procedure, and by leach tests in countries other than the USA including but not limited to Switzerland, Mexico, Taiwan, Japan, China, Canada, Germany, and Europe.
